(19) United States
(12) Patent Application Publication
(10) Pub. No.: US 2009/0061385 A1
(43) Pub. Date: Mar. 5, 2009

(54) Monolithic Dental Implant With Natural Load Response

(76) Inventors: James K. Bahcall, Buffalo Grove, IL (US); F. Kris Olsen, Shorewood, WI (US); Mark Arthur Fiorina, Elm Grove, WI (US); Mark Andrew Fiorina, Elm Grove, WI (US); James A. Davidson, San Juan Capistrano, CA (US)

Correspondence Address: QUARLES & BRADY LLP, 411 E. WISCONSIN AVENUE, SUITE 2040, MILWAUKEE, WI, 53202-4497, US

(21) Appl. No.: 12/031,037

(22) Filed: Feb. 14, 2008

Related U.S. Application Data
(60) Provisional application No. 60/970,003, filed on Sep. 5, 2007.

(51) Int. Cl. A61C 8/00

(52) U.S. Cl. 433/173

(57) ABSTRACT

A monolithic dental implant is provided made from a material or materials having a elasticity moduli less than approximately 4 Msi. The materials can be either a polymer or a composite material having a polymer matrix and a fiber- or particulate-reinforced second phase. When subject to occlusive forces, the monolithic dental implant provides improved lateral transmission of the forces, resulting in a reduction in bone resorption. Additionally, because the dental implant is monolithic, it is not subject to the problems associated with bacteria collection and abrasive wear common to multi-component dental implants.

### CROSS-REFERENCE TO RELATED APPLICATIONS

This application claims the benefit of U.S. Provisional Application No. 60/970,003, filed Sep. 5, 2007, and the entire disclosure of which is incorporated herein by reference.

### STATEMENT OF FEDERALLY SPONSORED RESEARCH OR DEVELOPMENT

Not applicable.

### BACKGROUND OF THE INVENTION

Teeth sit within sockets in the alveolar bone of the upper and lower jaw. Each socket is lined with a connective tissue known as the periodontal membrane or ligament. This periodontal membrane connects to a calcified connective tissue, known as cementum, that covers the roots of the teeth. In a healthy mouth, these connective tissues between the teeth and the bone anchor the teeth in the sockets and absorb shock when the teeth are subject to occlusive forces during mastication.

In an unhealthy mouth, periodontal disease may result in severe damage to the connective tissues that hold the teeth in the sockets. Periodontal disease is a progressive process that results in the destruction of the periodontal membrane, the receding of the gums, and, ultimately, the destruction of the alveolar bone (jawbone). In advanced stages, the disease can lead to the loosening of teeth, and the need to extract and replace the teeth.

A variety of tooth replacements commonly referred to as dental implants, have been developed over the years. These dental implants typically comprise a stiff metal post screwed or press-fit into the alveolar bone to act as an anchoring post, an abutment to which a crown or tooth prosthetic will attach, and an abutment screw to attach the abutment to the anchoring post. Typically, the anchoring post is made of a rigid metal or ceramic material having a modulus of elasticity much greater than modulus of elasticity of the alveolar bone. The modulus of elasticity of the alveolar bone is typically in the range of 0.5 Msi to 2.0 Msi. In contrast, an anchoring post made of titanium can have a modulus of elasticity exceeding 15 Msi. Titanium is frequently the preferred material because titanium osseointegrates with the bone and is a biocompatible material. Ceramics can also be used and are favored by some patients because ceramics provide a more natural looking implant than titanium. However, most ceramics have an even higher modulus of elasticity than titanium and, furthermore, are subject to microcracking.

Known dental implants have many disadvantages and present many problems. Dental implants having a high modulus of elasticity do not simulate the natural shock absorbing behavior of natural teeth having a periodontal membrane. This lack of a natural cushion hinders the implant from properly transmitting the occlusive forces into the alveolar bone in a natural manner. This problem is particularly acute when the implant is cylindrically-shaped. In a cylindrical implant, the occlusive forces are predominately transferred through the implant to the distal end of the dental implant, while providing less than normal lateral forces. The addition of threads can improve the transmission of lateral forces, but is still less than optimum.

Improper transmission of lateral forces is a significant problem because it can lead to stress shielding of the surrounding bone. This stress shielding can cause the under-stressed areas of the alveolar bone to decalcify and weaken. The weakened areas of bone around the implant are resorbed and result in the destabilization and loosening of the dental implant. Ultimately, this bone resorption can result in the rejection of the dental implant.

Other inventors have attempted to address the problems of load transfer of implants to the surrounding bone. In U.S. Pat. No. 5,453,007 to Wagher, an interchangeable implant is disclosed that has multiple components with various moduli of elasticity. However, a rigid first cylindrical element must be inserted into the jawbone. U.S. Pat. No. 6,152,738 to Aker discloses a threaded, periodontal ligament for insertion into a socket to receive a dental implant, presumably composed of titanium (although the material is not explicitly disclosed by Aker), to improve load distribution to the surrounding bone. U.S. Pat. No. 6,193,516 to Story describes a dental implant comprising a metal core surrounded by a polymeric cylindrical shell. U.S. Pat. No. 6,840,770 to McDevitt discloses a dental implant having a polymeric sheath inserted into the jawbone and a rigid implant that is inserted into the polymeric sheath. When the rigid implant is inserted into the polymeric sheath, the polymeric sheath is expanded and fixes the implant in the bone.

However, these inventions do not alleviate all of the problems described above and, indeed, tend to create other problems. The stiff metal portion found in Wagher, Aker, and Story can compromise load transfer to adjacent bone. These solutions are designed to maximize the initial stability of the implant and the ability of the occlusive forces to minimize movement of the proximal occlusive bearing area. However, this initial stability is attained at the expense of poor load transfer. These solutions do not provide sufficient lateral transmission of occlusive forces and, in the long run, may tend to exhibit problems with bone resorption and dental implant retention.

Moreover, all of the patents noted above include multiple component implants that can collect bacteria and produce abrasive wear debris within the interface between the components. Such particulate debris is well known to produce lysis, which can lead to inflammation and destruction of the adjacent supportive tissue. In U.S. Pat. App. 2005/0266382, Soler discloses a one piece dental device having a plastic core and a metal coated surface. Soler does not give a reason for using a one-piece dental implant, however, and the disclosed implant requires a metal-coated surface for biocompatibility.

Related to load transference are the problems associated with the axial deflection of the crown or other dental prosthesis. Occlusive forces generate compressive, tensile, and shear forces not only on the implant anchor, but also on the abutment containing the working surface of the dental prosthesis. Various attempts have been made to better accommodate these forces, but these attempts have achieved only limited success. In U.S. Pat. No. 5,026,280, Durr suggests that a sliding sleeve might be used. However, Durr's proposed invention only accommodates occlusive forces in a single direction. In U.S. Pat. No. 5,114,343, a spring-loaded device is located below the tooth surface to permit deflection of the crown in various directions. However, the cavity in which the spring is located can attract unwanted plaque, debris, and bacteria. And, aside from the apparent problems associated with a mechanical spring system being present in the oral cavity, the metal components can initiate an undesirable galvanic corrosion process and the release of metal ions.

Others have attempted to use polymeric materials in the fabrication of a dental implant. U.S. Pat. No. 5,723,007 to Engel describes a polymer dental implant that contains low-strength collagen of felt fiber to allow for pre-seeding human cells to the implant surface. U.S. Pat. No. 5,502,087 to Tatoesian describes a composition and method of making a dental prosthesis, formed from a single polymer having an Izod impact strength of at least 2.5 ft-lb/in. Tatoesian, however, only uses a single polymer which is chosen for its high flexural strength and toughness. In U.S. Pat. No. 4,535,485, Ashman discloses implantation of loose polymeric particles coated with hydrophilic material and barium sulfate particles for improved integration into the body. However, this prosthesis would only be suitable for bone or hard tissue replacement in a contained area, since the particles are loose when inserted. Thus, Ashman is unsuitable for connection to a crown or other dental prosthesis. In U.S. Pat. No. 5,716,413, Walter discloses shapeable low-modulus biodegradable polymeric implant material. Walter's invention is unsuitable for use as a dental implant because it would biodegrade over time.

Hence, it would be desirable to provide a dental implant that transmits occlusive forces to the surrounding bone in a more natural manner and reduces the effects created by stress shielding.

### BRIEF SUMMARY OF THE INVENTION

The present invention provides a monolithic dental implant that is capable of transmitting occlusive forces in a normal manner. By mimicking the elastic behavior the periodontal membrane, the monolithic dental implant prevents the resorption of bone caused by stress shielding. Thus, the present invention provides a dental implant that is capable of long term stability in the socket.

Structurally, the monolithic dental implant extends from a distal end, which interfaces with the bone within the socket, to a proximal end, which has an abutment for attaching a crown or other dental prosthetic. The distal end may taper as it extends from the gums down to the distal end of the implant. This taper improves the lateral transmission of occlusive forces.

The monolithic dental implant is a single component to which a crown or other dental prosthesis may optionally be attached. In one aspect, the monolithic dental implant is composed of a single material throughout, such as a polymeric material. In another aspect, the present invention comprises two or more zones or regions of integrally connected polymeric materials. Because the monolithic dental implant is a single component, the present invention does not experience the problems of accumulation of bacteria, plaque, and debris occurring at the interface between the multiple components found in many prior art dental implants.

In one embodiment, a dental implant mountable into a socket of a jaw has a monolithic body defining a proximal end, a distal end and a medial section extending between the ends to integrally join the ends together and form a single unitary structure. The distal end is adapted for attachment to the socket. When the distal end is in the socket, the medial section is adjacent a gum line of the jaw. The proximal end defines an abutment for mounting a dental prosthetic so that the prosthetic projects above the gum line when the distal end is in the socket. Further, the distal end has an elastic modulus of less than 4 Msi and tapers in the direction away from the proximal end such that the dental implant has a load response and a load distribution to occlusive forces that approximate that of a natural tooth. The distal end, proximal end, and medial section can all include polymeric materials.

In another embodiment, the monolithic dental implant has three zones. The first zone is a distal surface zone that is a thin layer extending from the distal end along the surface of the dental implant that could make contact with the bone. The second zone is a proximal core zone that extends from the proximal end into the bulk of the dental implant. The third zone is a medial zone that is located between the distal surface and proximal core zones. Other embodiments are contemplated including an embodiment in which the distal surface zone and medial zone described above are combined into a single zone to form a two zone implant with the proximal core zone. Additionally, an embodiment is contemplated in which the medial and proximal core zones described above are combined into a single zone to form a two zone implant with the distal surface zone.

When two or more zones are present in this embodiment of the invention, each zone can be composed of a low-modulus polymeric material or a fiber- or particulate-reinforced polymeric material with an elastic modulus below approximately 4 Msi. The selection of materials for each of the zones can be ordered such that the material having the lowest modulus of elasticity is located in the zone most near the distal portion of the dental implant. In this way, the most elastic material is capable of mimicking the periodontal membrane and normally transferring occlusive forces. However, it is also possible that a lower stiffness zone may be sandwiched between to low stiffness zones. In that case, the dental implant may provide the benefit of having periodontal membrane-like mechanical behavior as the result of the lower stiffness zone, while the low stiffness zone that actually contacts the bone provides a slightly stiffer material to provide a more cohesive and durable interface.

In some embodiments of invention, the surface of the dental implant can be modified. For example, the distal portion of the surface of the dental implant may be fabricated to have threads that can be directly threaded into a bone socket. Similarly, the surface may incorporate antibiotics, bone growth agents, and anti-inflammatory agents.

These and other features and advantages of the invention will appear in the detailed description which follows. In the description, reference is made to the accompanying drawings which illustrate a preferred embodiment of this invention.

### BRIEF DESCRIPTION OF THE DRAWINGS

FIG. 1 is a front sectional view of an embodiment of the monolithic dental implant being composed of a single material;

FIG. 2 is a front sectional view of an embodiment of the monolithic dental implant having three zones;

FIG. 3 is an environmental view of the monolithic dental implant shown in FIG. 2, with the monolithic dental implant shown in a socket in the mouth;

FIG. 4 is an environmental view of a monolithic dental implant according to another embodiment that has two zones; and

FIG. 5 is an environmental view of another two-zone embodiment of the monolithic dental implant of the present invention.

### DETAILED DESCRIPTION OF THE PREFERRED EMBODIMENTS

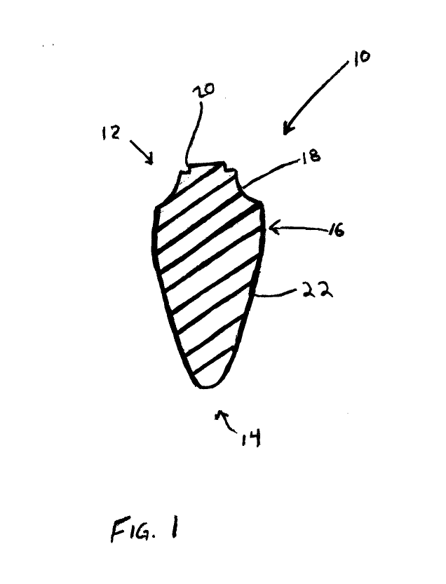

Referring now to FIG. 1, a dental implant 10 is shown. The dental implant 10 is monolithic in structure. The dental implant extends from a proximal end 12 to a distal end 14 and has a middle portion 16. The dental implant 10 has an abutment 18 that slopes upward and is slightly concave as it extends from the middle portion 16 to the proximal end 12. A cap 20 that is suitable for connection to a dental prosthesis is located in the center of the abutment 18 at the proximal end 12. The dental implant 10 also has a tapered surface 22 that extends from the middle portion 16 to the distal end 14 of the dental implant 10. The tapered surface 22 narrows as it extends from the middle portion 16 towards the distal end 14.

It should be appreciated that the overall shape of the dental implant 10 may differ from that shown in FIG. 1. It is intended that other dental implant geometries are within the scope of this invention.

It is contemplated that the materials used in this invention can be polymeric materials. For example, any thermoset polymer (phenolics and the like), thermoplastic polymer (polyolifins, nylons, polyether keytones, and the like) or self-curing monomers (acrylics and the like) are useful for the present invention and included within the scope of this invention, as well as combinations of these polymers. Moreover, the materials used in this invention can include polymeric composite materials including a second phase such as ceramic fillers such as glass fibers, carbon fibers or nanotubes, and the like. However, it is contemplated that other materials, such as metals and ceramics, may also be used in the fabrication of the dental implant.

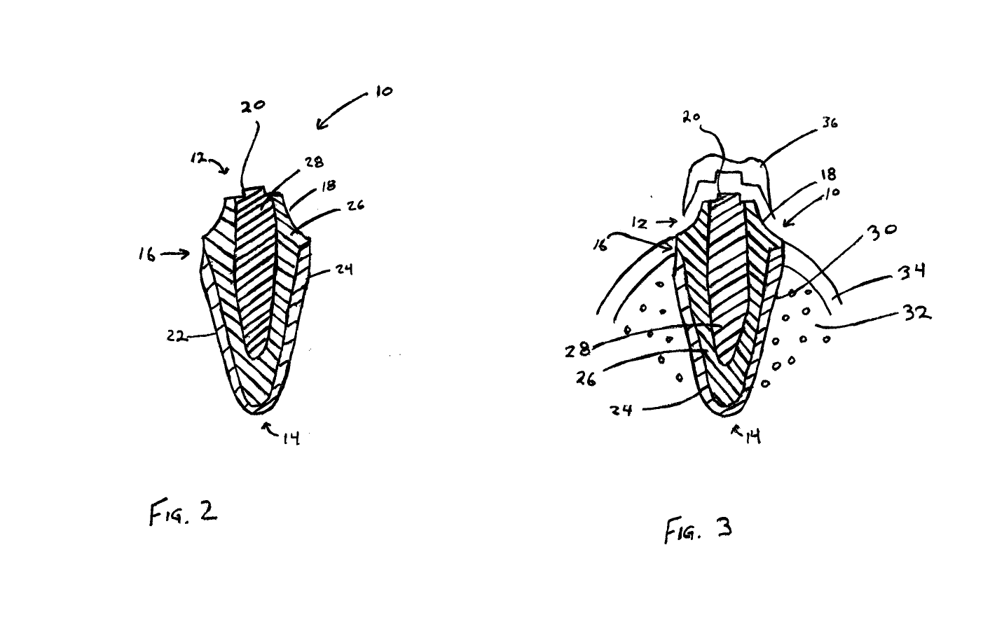

Referring now to FIG. 2, the dental implant 10 is shown as having three integrally connected zones: a distal surface zone 24, a medial zone 26, and a proximal core zone 28. The distal surface zone 24 comprises a substantial portion of the tapered surface 22 that extends from the distal end 14 to the middle portion 16. The thickness of this distal surface zone 24 can be less than about 1 mm. The proximal core zone 28 extends from the proximal end 12 at the top of the abutment 18 axially down into the center of the dental implant 10. As shown, the proximal core zone 28 includes the cap 20 on the top of the abutment 18. The medial zone 26 is the remaining material in the dental implant 10 that is sandwiched between the distal surface zone 24 and the proximal core zone 28. Each of the three integrally connected zones can be composed of a different material having a modulus of elasticity less than approximately 4.0 Msi.

In one embodiment, the distal surface zone 24 is composed of a low modulus material, the medial zone 26 is composed of a stiffer material, and the proximal core zone 28 is composed of an even stiffer material. For example, the distal surface zone 24 can be composed of a low-modulus polymeric material having a stiffness below approximately 0.8 Msi; the medial zone 26 can be composed of a low modulus polymeric material having a modulus between approximately 0.8 Msi and 4.0 Msi; and the proximal core zone 28 can be composed of a material having an elastic modulus greater than the medial zone 26, but still less than approximately 4.0 Msi. It is contemplated that the proximal core zone 28 can be composed of either a low-modulus polymeric material or a fiber- or particulate-reinforced polymeric material. For example, the dental implant 10 can have a proximal core zone 28 composed of a fiber-reinforced polyetheretherkeytone (PEEK) material, a medial zone 26 composed of a polymeric material having a modulus of elasticity between 0.8 and 4.0 Msi, and a distal surface zone 24 composed of a polymeric material having an modulus of elasticity less than 0.8 Msi.

In yet another embodiment, the medial zone 26 is composed of a low-modulus of elasticity material sandwiched between the distal surface zone 24 and the proximal core zone 28, each of which have a greater modulus of elasticity than the medial zone 26. For example, the medial zone 26 can be composed of a low-modulus material having a modulus of elasticity between approximately 0.8 Msi and 4.0 Msi. The distal surface zone 24 and the proximal core zone 28 can be composed of a fiber- or particulate-reinforced polymeric material or materials each having a modulus of elasticity greater than the medial zone 26, but less than approximately 4.0 Msi.

It should be appreciated that other embodiments, having other combinations of material arrangement based on relative elasticity, are contemplated.

As described above, it is also contemplated that one or more zones of the dental implant 10 may be composed from polymeric materials with a second reinforcing phase, such as a fiber phase or a particulate phase. Ceramic materials, in particular glass, and carbon nanotubes have been recognized as effective materials for addition as a second phase.

It should be observed that due to the geometry of the dental implant 10, the names of the zones such as the distal surface zone 24, the medial zone 26, and the proximal core zone 28 are only rough descriptors. For example, portions of the distal surface zone 24 may be located more closely to the proximal end 12 than portions of the medial zone 26. Likewise, portions of the proximal core zone 28 may be located more closely to the distal end 14 than portions of the medial zone 26.

It should also be appreciated that although three zones are described in the previously-described embodiments, a different number of zones can exist in the dental implant 10. It is contemplated that there can be one or more zones. As will be described below, in various embodiments, two of the three zones described above can be combined to form a single larger zone. Likewise, additional zones can be added without deviating from the spirit of this invention. Moreover, it is contemplated that the zones may have geometries other than those shown in the figures.

FIG. 3 shows an environmental view of the dental implant 10 placed inside a socket 30 defined by a jawbone 32 and gums 34. It can be seen that the distal surface zone 24 forms an interface with the alveolar bone or jawbone 32 and a portion of the gums 34. Additionally, a portion of the surface of the medial zone 26 makes contact with the gums 34. The abutment 18 protrudes out of the gums 34. This abutment 18 and its associated cap 20 provide a point of attachment for a crown 36 or other dental prosthesis.

It should be appreciated that the dental implant 10, when subject to occlusive forces, can mimic the mechanical response of a natural tooth having a periodontal membrane. Because the materials of dental implant 10 are elastic relative to the known rigid dental implants, the dental implant 10 will, at least in part, provide some level of shock absorption, similar to the periodontal membrane. Because the dental implant 10 provides some amount of shock absorption, the entire occlusive load is not transferred to the jawbone 32 at a single moment, and therefore the jawbone 32 is subject to a more evenly distributed dispersed load.

It should also be appreciated that the tapered surface 22 also assists in the natural transference of occlusive forces. Unlike the cylindrical prior art implants that transferred the occlusive load almost exclusively in the axial direction, the tapered surface 22 permits a more natural transference of occlusive forces. In particular, the lateral transmission of occlusive forces is greatly improved because of the taper. This improved lateral transmission results in the reduction of stress shielding which, in turn, results in a reduction in the amount of bone resorption. As described above, bone resorption is detrimental to the long-run stability of the dental implant 10 because the jawbone 32 surrounding the dental implant 10 will weaken or disappear. This bone resorption can destroy the interface between the dental implant and the jawbone, resulting in rejection of the dental implant in the mouth.

It should be appreciated that the present invention not only provides a more even and efficient load transfer to the jawbone 32, but also is more load-forgiving of occlusive forces at the point where the crown 36 or other dental prosthesis connects to the dental implant 10. For example, depending on materials selection and design, the dental prosthesis can laterally deflect up to 0.8 mm and compressively deflect up to 0.5 mm. However, given the manner in which the distal end 14 anchors the dental implant 10, the rotational deflection of the dental prosthesis can be less than 0.2 mm. Additionally, various design features, including cross-sectional shape, threads, holes, porous surfaces, and the like can incorporated within the dental implant 10 which can alter the elastic response of the dental implant 10. Thus, the dental prosthesis replicates the mechanical response of a natural tooth when subject to occlusive forces.

It should observed that the crown 36 or other dental prosthesis can be attached in a number of ways. The dental prosthesis can be attached to the dental implant 10 via molding, dipping (casting), polymerizing, gluing, or welding to the proximal end 12 of the dental implant 10. Similarly, the dental prosthesis can be mechanically attached to the dental implant 10 by means such as screwing, press-fitting, and the like. Additionally, a combination of mechanical and non-mechanical attachment means might be employed. Multiple molding, dipping, and other polymerization steps can also be employed or combinations of these, known to those skilled in the art, and are within the scope of the invention.

It should also be observed that the interface between the distal surface zone 24 and the socket 30, specifically with the jawbone 32, can have a number of configurations. For example, the distal surface zone 24 of the dental implant 10 can have threads, such that the dental implant 10 can be threaded directly into the socket 30. Furthermore, various surface enhancements can be placed on the distal surface zone 24 to improve osseointegration of the dental implant 10 with the jawbone 32 and to prevent complications from arising. Such surface enhancements include, but are not limited to, the use of various additives, the creation of a textured or porous surface on the distal end 14, the application of bone growth factors such as hydroxylapatite or calcium phosphate, and the like. Likewise, antibiotic agents can be partially incorporated in the distal surface zone 24 or attached to the outer surface of the distal surface zone 24 to limit the harm of infections in the socket 30.

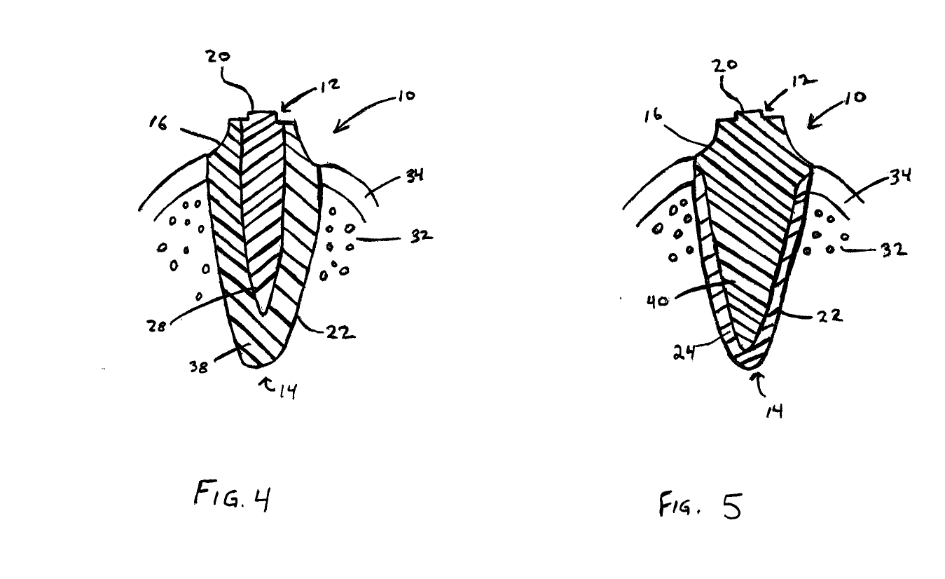

FIGS. 4 and 5 show additional environment views of the dental implant 10, in which the structure of dental implant 10 has been modified such that two of the three zones as shown in FIGS. 2 and 3 have been combined. In FIG. 4, the distal surface zone 24 and the medial zone 26 have been combined to form an enlarged distal zone 38. In this configuration, the enlarged distal zone 38 extends from the interface of the socket 30 and the gums 34 to the proximal core zone 28. In FIG. 5, the medial zone 26 and the proximal core zone 28 have been combined to form an enlarged proximal zone 40. In this configuration, the enlarged proximal zone 40 comprises the main body of the dental implant 10, with the distal surface zone 24 comprising only a thin outer layer covering the body of the dental implant 10.

There may be various reasons for employing a two-zone design instead of a three-zone design. A two-zone dental implant may be easier to fabricate than a three-zone design. A two-zone design may also cost less to produce. Additionally, a two-zone design may provide a sufficient number of zones to supply the desired elastic properties for dental implants 10 used in a particular part of the mouth or replacing particular types of teeth, making the need for a third zone of elasticity unnecessary.

In one embodiment, the enlarged distal zone 38 is composed of a low stiffness polymeric material having a modulus of elasticity between approximately 0.8 Msi and 4.0 Msi. In this embodiment, the proximal core zone 28 is composed of a fiber- or particulate-reinforced polymeric material that has a modulus of elasticity that is higher than the modulus of elasticity of the enlarged distal zone 38. In one specific embodiment, the fiber- or particulate-reinforced polymeric material can be a polyetheretherkeytone (PEEK) with a second reinforcing phase.

In another embodiment, the enlarged proximal zone 40 is composed of a low stiffness polymer having a modulus of elasticity between approximately 0.8 Msi and 4.0 Msi. In this embodiment, the distal surface zone 24 is composed of a polymeric material having an even lower modulus of elasticity, below approximately 0.8 Msi.

In yet another embodiment, the enlarged proximal zone 40 is composed of a fiber- or particulate-reinforced polymeric material. In this embodiment, the distal surface zone 24 is composed of a low-modulus polymeric material having a modulus of elasticity less than approximately 0.8 Msi. In one specific embodiment, the fiber- or particulate-reinforced polymeric material can be a polyetheretherkeytone (PEEK) with a second reinforcing phase.

It should be appreciated that although FIGS. 3-5 show multi-zone dental implants in the socket 30, that the single-zone dental implant shown in FIG. 1 may also be placed in a socket 30.

In each case, the dental implant 10 will replace an unhealthy tooth in the socket 30. The dental implant 10 will be inserted into the socket 30 and held in place by either a mechanical means (such as threads and the like) or a biological or chemical means (such as hydroxylapatite, the inclusion of a porous surface to increase biocompatibility, and the like). No rigid materials are used in construction of the dental implant 10 and thus some amount of initial stabilization of the dental implant 10 in the socket 30 is sacrificed. However, in the long run, the improved load transference will reduce the amount of bone resorption which, in turn, improves the long term acceptance of the dental implant 10 in the mouth.

Once the dental implant 10 set in the socket 30, a crown 36 or other dental prosthesis is placed on the cap 20 on the top of the abutment 18. This crown 36 will function similar to the top portion of the tooth that it replaced when subject to the occlusive loads induced by chewing. The elastic material within the dental implant 10 deflect when subjected to occlusive forces. These zones can mimic the natural behavior of the periodontal membrane to transmit the occlusive forces into the jawbone 32 in a normal manner. Specifically, these zones will transmit the forces to both the distal end 14 and laterally to the interface between the dental implant 10 and the jawbone 32 formed at the tapered surface 22. In particular, the lateral transmission of occlusive forces prevents stress shielding and reduces the amount of bone resorption that occurs.

Moreover, because the dental implant 10 is made of materials having an elastic modulus less than approximately 4.0 Msi, the dental implant 10 is better at absorbing the shock of the occlusive forces to better reduce the peak load on the jawbone 32. The dental implant 10 distributes the force over a longer amount of time as the dental implant 10 elastically deflects under the occlusive load.

It is specifically intended that the present invention not be limited to the embodiments and illustrations contained herein, but include modified forms of those embodiments including portions of the embodiments and combinations of elements of different embodiments as come within the scope of the following claims.

We claim:

1. A dental implant mountable into a socket of a law, the dental implant comprising a monolithic body defining a proximal end, a distal end and a medial section extending between the proximal end and the distal end to integrally join the proximal end and the distal end together and form a single unitary structure, the distal end being adapted for attachment to the socket, the medial section being adjacent a gum line of the jaw when the distal end is in the socket, the proximal end defining an abutment for mounting a dental prosthetic so that the dental prosthetic projects above the gum line when the distal end is in the socket, wherein the distal end has an elastic modulus of less than 4 Msi and tapers in a direction away from the proximal end such that the dental implant has a load response and a load distribution to occlusive forces that approximate that of a natural tooth.

2. The dental implant of claim 1, wherein the distal end includes polymeric material.

3. The dental implant of claim 2, wherein the proximal end and medial section of the body each include polymeric material.

4. A dental implant having a natural load response, the dental implant comprising: a body having a distal end for attachment to a bone, a proximal end for mounting a dental prosthetic, and a surface, the body having a first zone composed of a first polymeric material having a first modulus of elasticity and a second zone composed of a second polymeric material having a second modulus of elasticity, the first zone being integrally connected with the second zone.

5. The dental implant of claim 4, wherein:
the first zone has an abutment on the proximal end of the body such that, when the dental implant is placed in a socket, the abutment will protrude from a gum line; and
the second zone covers at least a portion of the distal end of the body and forms an interface with the bone.

6. The dental implant of claim 5, wherein the first modulus of elasticity and the second modulus of elasticity are each less than 4 Msi.

7. The dental implant of claim 5, wherein the first polymeric material is a composite material having a polymeric matrix and a reinforcing phase.

8. The dental implant of claim 7, wherein the second modulus of elasticity is less than 0.8 Msi.

9. The dental implant of claim 8, wherein the second zone is a thin layer having a thickness of less than 1 mm.

10. The dental implant of claim 6, wherein the second modulus of elasticity is less than 0.8 Msi.

11. The dental implant of claim 10, wherein the second zone is a thin layer having a thickness of less than 1 mm.

12. The dental implant of claim 4, the body further comprising a third zone, the third zone being located between and being integrally connected to the first zone and the second zone and being composed of a third polymeric material having a third modulus of elasticity.

13. The dental implant of claim 12, wherein:
the first polymeric material is a composite material having a polymeric matrix and a reinforcing phase and the first modulus of elasticity is less than 4 Msi;
the second modulus of elasticity is less than 4 Msi; and
the third modulus of elasticity is less than 4 Msi.

14. The dental implant of claim 13, wherein the second modulus of elasticity is less than 0.8 Msi.

15. The dental implant of claim 13, wherein the second polymeric material is a composite material having a polymeric matrix and a reinforcing phase.

16. The dental implant of claim 13, wherein the third modulus of elasticity is between 0.8 Msi and 4 Msi.

17. The dental implant of claim 13, wherein the third modulus of elasticity is less than 0.8 Msi.

18. The dental implant of claim 4, further comprising a surface coating that covers at least a portion of the surface of the body to accelerate attachment of the dental implant to the bone.

19. The dental implant of claim 18, wherein the surface coating is an osteogenic agent.

20. The dental implant of claim 4, wherein at least a portion of the second material is porous to promote osseointegration with the bone.

21. The dental implant of claim 4, wherein:
the second zone forms an interface with at least a portion the bone and at least a portion of a gums, the second zone forming an abutment protruding from the gums on the proximal end of the body; and
at least a portion of the first zone is exposed at a top of the abutment formed by the second zone.
